(19) United States
(12) Patent Application Publication
(10) Pub. No.: US 2015/0006620 A1
(43) Pub. Date: Jan. 1, 2015

(54) SCALABLE MANUFACTURING FACILITY MANAGEMENT SYSTEM

(71) Applicant: Applied Materials, Inc., Santa Clara, CA (US)

(72) Inventors: Monica Joseph, Chennai (IN); Amudhasagaran Nadesan, Fremont, CA (US)

(21) Appl. No.: 14/316,428

(22) Filed: Jun. 26, 2014

Related U.S. Application Data
(60) Provisional application No. 61/840,391, filed on Jun. 27, 2013.

(51) Int. Cl. H04L 29/08

(52) U.S. Cl. CPC H04L 67/10
USPC 709/203

(57) ABSTRACT

Methods and systems are provided for event handling for a scalable manufacturing facility management system. A combined server receives a message from a client and stores the message in a message queue. A task corresponding to the message is created, and the combined server determines whether to execute the task locally by the combined server or by a remote combined server. In response to the combined server determining that the task is to be executed locally, the task is executed by the combined server. In response to the combined server determining that the task is to be executed remotely, the task is transmitted to the remote combined server to be executed.

### CROSS REFERENCE TO RELATED APPLICATION

This application claims the benefit of priority of U.S. Provisional Patent Application No. 61/840,391, filed Jun. 27, 2013, which is hereby incorporated by reference herein in its entirety.

### TECHNICAL FIELD

Embodiments of the present invention relate generally to computer systems for managing a manufacturing facility, and more particularly to event handling for a scalable manufacturing facility management system.

### BACKGROUND

Typically, a manufacturing facility is managed using multiple servers. The facility can be used to manufacture semiconductors, solar devices, display devices, batteries, etc. In particular, various client computers in a manufacturing facility (e.g., manufacturing tools configured to report information about themselves, user operated machines, systems that move lots from one part of the facility to another, etc.) send numerous messages to an event services server cluster. The event services server cluster manages asynchronous message processing between servers and clients in the manufacturing facility. Because of high traffic in the manufacturing facility, the event services server cluster can be overloaded and unable to keep up with factory messaging demands when using conventional systems. A conventional event services server cluster includes two servers in a failover configuration that function as a single node, which impedes system scalability as manufacturing volume increases.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a block diagram of a system which is configured for event handling in a scalable manufacturing facility, in accordance with the presently disclosed subject matter;

FIG. 2 is a block diagram illustrating the processing of a message issued by a client, in accordance with some embodiments.

FIG. 3 illustrates one embodiment of a method for load balancing a client message, in accordance with some embodiments.

FIG. 4 illustrates one embodiment of a method for processing a client message and executing a task by a combined server having event services and application server functionality, in accordance with some embodiments.

FIG. 5 illustrates a diagrammatic representation of a machine in the exemplary form of a computer system within which a set of instructions, for causing the machine to perform any one or more of the methodologies discussed herein, may be executed.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Embodiments of the present invention provide an efficient and scalable mechanism for managing a semiconductor manufacturing facility. The facility may be used to manufacture semiconductor devices, solar devices, display devices, batteries, or any other device or item. A Manufacturing Execution System (MES) can be used to manage operations of a manufacturing facility. The MES can use multiple servers for various operations. The MES can be used for directing materials and tools, managing product definitions, dispatching and executing production orders, chip tracking, analyzing production performance, etc. Clients and servers in the MES can process large quantities of data associated with manufacturing activities and can publish these data as events or messages, which are received and processed by subscribers (e.g., servers, clients). Conventional MES systems use a single event services server cluster that handles all messaging within the MES. As the MES increases in scale, so does the amount of messages within the MES. The single event services server cluster then creates a bottleneck that impedes manufacturing operations. To address this, aspects of the present disclosure include a combined server that hosts a business logic module to provide application server functionality and an event services module to handle message processing between servers and clients within the manufacturing facility. By integrating event services (e.g., publish, subscribe, dispatch) and application server functionality into a single combined server, the inefficiency inherent in running event services on separate, highly available, lightly loaded servers is eliminated. To solve the bottleneck that is present in conventional MES systems, one or more combined servers with messaging functionality can be added as the MES increases in scale. The messaging functionality of the combined server includes a message queue that receives messages (e.g., asynchronous communications, requests, etc.). Messages are placed in the queue and when combined server logic is ready to handle a particular message, it can obtain the particular message from the queue. The queue contributes to MES efficiency since the combined server can obtain and process messages when it is ready. When ready, the combined server processes a message and publishes the processed message as a task. By using a single combined server to handle these operations, the footprint required to manage a manufacturing facility is reduced while an even distribution of workload and event handling between the combined servers within the facility is maintained. Also, by using a combined server, a manufacturing facility is better suited to meet scalability demands through adding more combined servers to the system as needed. By distributing event services among multiple combined servers, software and firmware upgrades to the servers also can occur without taking the entire system down.

As the term is used herein, a message is an asynchronous message when an entity that creates the message does not wait for it to be executed before creating a next message. For example, if a message is stored in a message queue at the server for later processing, the message can be referred to as an asynchronous message. Asynchronous can also mean intermittent and can also mean that the recipient of the message is not available at the time it receives the message.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

A client in a manufacturing facility can send a message to a combined server for processing. Messages within the manufacturing facility may be any type of message (e.g., XML) and may relate to many different topics. In many cases, messages contain information about an activity that happened at a client or at equipment associated with or attached to the client, such as requests for changing the states of tools at a certain time in order to perform preventative maintenance, automated requests sent by a manufacturing tool, client requests that are to be executed concurrently by the application servers (e.g., a request to create a lot for processing and then to track the processing of the lot at a future time) such that a client does not wait for one message to be handled before creating a next message, etc. When the manufacturing facility has multiple combined servers and each combined server has an event services module that processes messages, a load balancer can determine which combined server is best suited to handle the message. After the load balancer determines the best suited combined server, the load balancer notifies the client, and the client sends the message to the selected combined server for further processing.

A combined server receives a message from the client. The combined server obtains the message after being selected by a load balancer. The combined server converts the message into an executable task and readies it for dispatch. When dispatching the executable task, the combined server can implement a load balancer to determine whether to execute the task locally by the combined server or on a remote combined server. If the task is to be executed locally, the combined server executes the task.

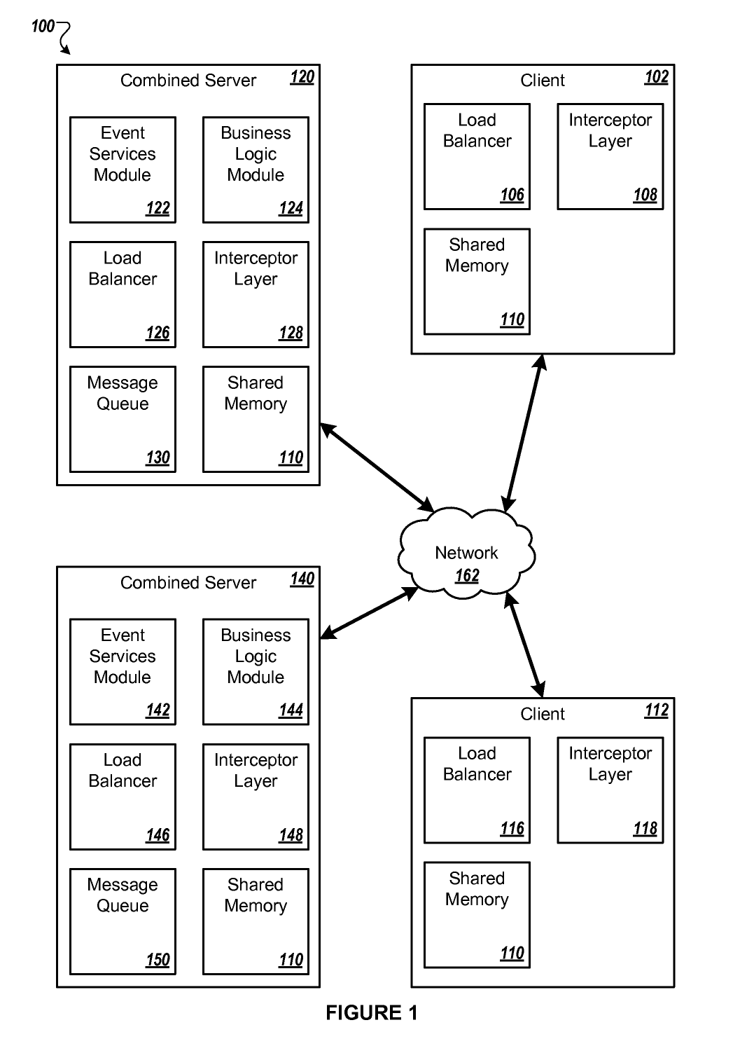

FIG. 1 illustrates a system architecture 100 in which embodiments of the present invention may be implemented. System 100 can include clients 102 and 112 and combined servers 120 and 140. Clients 102 and 112 can be coupled to combined servers 120 and 140 via a network 162, which can be a private network (e.g., a local area network (LAN)) or a public network (e.g., the Internet), or a combination thereof.

Clients 102 and 112 can be external systems such as ones that move lots from one part of the facility to another, manufacturing tools configured to report information about themselves, user operated machines, etc. Clients 102 and 112 can report on the various tasks they perform by transmitting messages to other nodes (e.g., combined servers) of the manufacturing facility. Clients 102 and 112 may contain load balancers 106 and 116, interceptor layers 108 and 118, and a shared memory 110. Load balancers 106 and 116, and interceptor layers 108 and 118 may be implemented in software, hardware, or a combination of hardware and software. Clients 102 and 112 may send asynchronous communications over the network 162 to one of the combined servers 120 and 140 based on a load balancing operation.

Combined servers 120 and 140 may contain, respectively, event services modules 122 and 142, business logic modules 124 and 144, load balancers 126 and 146, interceptor layers 128 and 148, message queues 130 and 150, and shared memory 110. Event services modules 122 and 142, business logic modules 124 and 144, load balancers 126 and 146, and interceptor layers 128 and 148 may be implemented in software, hardware, or a combination of hardware and software. Combined servers 120 and 140 can implement highly available services that are needed to handle messaging and event services within the manufacturing facility. These highly available services handle receiving, processing and dispatching messages and executable tasks. Example messaging services software that can be implemented by the combined servers include Microsoft Message Queuing™ (MSMQ) available from Microsoft Corporation of Redmond, Wash. or Rendezvous™ (RV) available from TIBCO Software of Palo Alto, Calif.

A message can be created by a client such as client 102. The message may be an asynchronous communication that is placed in a message queue, such as message queue 130 or 150, and obtained at a later time by another node. For example, the client may transmit a message to a server. The message can remain in the message queue for any length of time. The message can likewise be removed at any time, such as when it is assigned to a combined server or business logic module, when it is received by a combined server or business logic module, when it is processed, or at any other time. The load balancer 106 or 116 can determine which combined server is best suited to receive the message. After being load balanced at the client 102 or 112, the message can be placed in or transmitted to a message queue, such as message queue 130 or 150 to be later handled by an event services module, such as event services module 122 or 142.

Interceptor layer 108 or 118 intercepts any message or request to be sent to a combined server made by clients 102 and 112 or by an event services module 122 or 142. The interceptor layer 108 or 118 communicates with load balancers 106, 116, 126 or 146, which determine which of the combined servers 120 and 140 is best suited to handle the message or request. Shared memory 110 is used to exchange information between clients and combined servers. Clients and combined servers can provide information about themselves in the shared memory 110, such as availability, current executing processes, current workload, a number of calls executing on one or more application servers etc. The information included in shared memory 110 can be used by the load balancer 106 or 116 to more evenly distribute the workload between combined servers. For example, shared memory 110 can include information about the availability and workload of combined servers 120 and 140.

Combined servers 120 and 140 can receive messages and can place them in message queues 130 or 150, respectively, until the combined server 120 or 140 is ready to handle the received message. Once combined server 120 or 140 is ready to handle the received message, it converts them into tasks to be executed by a business logic module, such as business logic module 124. Event services modules 122 and 142 may provide these highly available services that are needed to handle messages within the manufacturing facility and which were previously handled by a separate event services server cluster. Example services residing in the event services modules 122 and 142 may include: the event services server, which handles the dispatching of messages; a PDController (Process Director Controller), which converts messages into executables tasks and forwards them to the least loaded application server (e.g., a task execution controller); and a TimerManager, which manages timer related tasks and scheduled activities like preventive maintenance.

In the illustrated embodiment, there are two combined servers 120 and 140 in system 100, however it should be understood that in other embodiments there may be any number of combined servers. In one embodiment, only combined servers 120 and 140 may include event services modules 122 and 142 while additional servers function as “application servers.” In other embodiments, all servers in system 100 may be “combined servers” that provide event services and application server functionality.

Business logic modules 124 and 144 may track the manufacturing process and collect and maintain data regarding the facility, as well as execute requests made by clients 102 and 112 and event services modules 122 and 142. By providing an event services module, a message queue, and a business logic module on the same machine, combined servers 120 and 140 therefore offer the same functionality as a separate application and event services servers while eliminating the inefficiency inherent in operating separate, highly available, lightly utilized event services servers.

In operation, before a client sends a message (e.g., an asynchronous communication) to a combined server, a decision can be made as to which of the combined servers 120 or 140 should process the message (e.g., convert to an executable task). In order to more evenly distribute the workload between combined servers, shared memory 110 may be populated on clients 102 and 112 and combined servers 120 and 140. A service running on client 102 and combined servers 120 and 140 can update the shared memory 110 with information regarding the availability and workload of combined servers 120 and 140. This information can be propagated among the various machines by use of Microsoft® Windows® Peer-to-Peer Networking services such that the clients 102 and 112 and the combined servers 120 and 140 communicate amongst each other.

Interceptor layer 108 or 118 intercepts any message or request to be sent to a combined server made by clients 102 and 112 or by an event services module 122 or 142. The interceptor layer communicates with load balancers 106, 116, 126 or 146, which determine which of the combined servers 120 and 140 is best suited to handle the message or request. Load balancer 106, 116, 126 or 146 can make this determination based on information obtained from shared memory 110. Clients and combined servers can provide this type of information to the shared memory 110 at any time, such as periodically, randomly, in response to a request from another component of the system, etc. The load balancer determination may be based on which application server is least lightly loaded. This can be determined based on the number of calls executing on each of the application servers at the time the request is made. Information about the number of calls is available in shared memory 110, and the request can be routed to whichever application server has the fewest number of calls executing. In some embodiments, the determination is made based in part on the number of calls executing on each combined server and in part on a least loaded and round robin distribution for more effective load balancing. In a round robin distribution, the load balancer can determine the best suited combined server on a turn-by-turn basis. For example, each new message or request can be assigned to a different combined server. Once all combined servers have been assigned a message or request, the load balancer can start over. Once the determination is made by load balancer 106 or 116, interceptor layer 108 or 118 sends the message to a message queue 130 or 150 on the appropriate combined server. This ensures that the workload is more evenly distributed between combined servers 120 and 140.

The message can remain in the message queue 130 or 150 until the combined server 120 or 140 is ready handle the message. The combined server 120 or 140 can handle the message at any time and in any order. In one implementation, received messages are handled in a first in, first out manner. In another implementation, received message are handled in a last in, first out manner. In further implementations, a client or combined server can assign a priority to messages. The combined server can handle message according to the assigned priority. In yet another implementation, messages can be handled based on the type of task. For example, all messages relating to a particular manufacturing operation can be handled before messages relating other operations. Further, each operation can be prioritized. The combined server can handle messages according to the priority of the operation they are associated with.

When the combined server 120 or 140 is ready to handle the message, the combined server 120 or 140 can then convert the message into a request (e.g., executable task) to send to a business logic module 124 and/or 144. For example, the combined server 120 or 140 can receive a message in XML format, and can convert the message to a format that is readable by the business logic module 124 or 144 when dispatching the task.

To more evenly distribute the aggregate workload between the combined servers, load balancing is performed not only for messages sent by clients 102 and 112 to the combined servers, but also for requests (e.g., executable tasks) made by the event services modules 122 and 142. To accomplish this, shared memory 110 is used in a manner similar to the mechanism described above. A service running on clients 102 and 112 and combined servers 120 and 140 updates the shared memory 110 with information regarding the availability and workload of combined servers 120 and 140. This information can be propagated among the various machines by use of peer-to-peer communication software, such that each of the combined servers 120 and 140 communicates with each other, as shown in FIG. 1.

When a request (e.g., an executable task) is dispatched by event services modules 122 or 142, interceptor layer 128 or 148 may intercept any requests that are to be sent to a business logic module (e.g., business logic module 124 or 144) for execution. The interceptor layer 128 or 148 may intercept any requests in a similar manner as it can intercepts messages, as described herein. The interceptor layer communicates with load balancer 126 or 146, which determines which of the combined servers 120 and 140 is best suited to execute the request. Information regarding the number of calls may be available in shared memory 110, and the request can be routed to whichever combined server has the fewest number of calls currently executing.

Once the determination is made by the load balancer, the interceptor layer sends the request to the appropriate server. If the request originated from an event services module (e.g., event services module 122 or 142) and the appropriate server is determined to be the combined server on which the event services module resides, the interceptor layer readies the request for execution locally. For example, if a request is made by event services module 122, interceptor layer 128 may intercept the request. Load balancer 126, in conjunction with shared memory 110, may determine which of combined servers 120 or 140 is best suited to execute the request. If it is determined that combined server 140 is least lightly loaded, the interceptor layer sends the request to combined server 140 for execution. Alternatively, if combined server 120 is least lightly loaded, interceptor layer 128 keeps the request for local execution by business logic module 124. This approach ensures that the workload is more evenly distributed between combined servers 120 and 140.

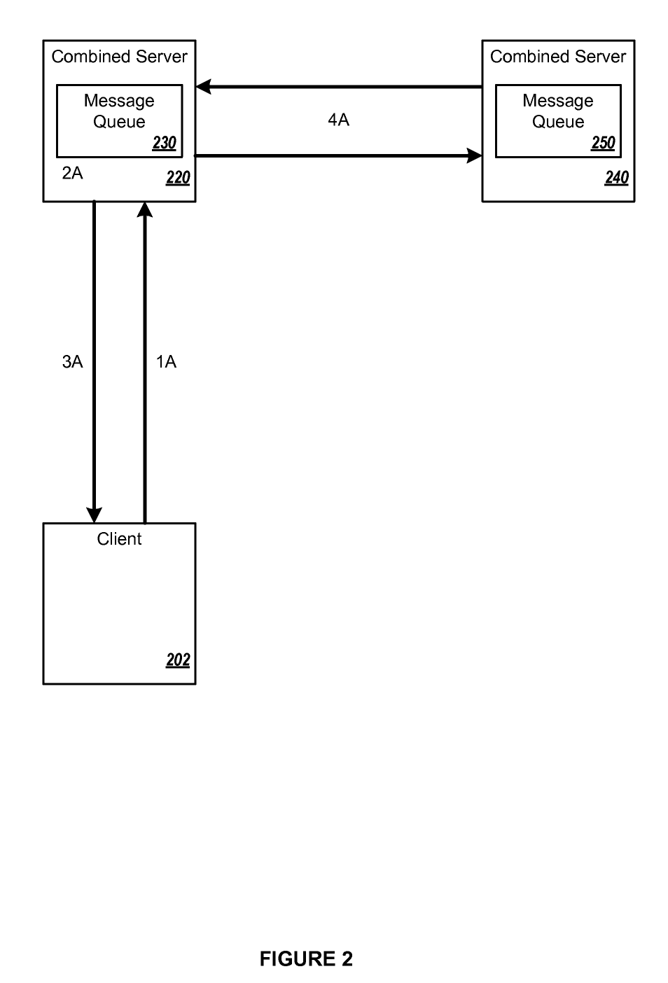

FIG. 2 is a block diagram illustrating the processing of a message issued by a client 202, in accordance with some embodiments. If the client message is an asynchronous communication, such as a create job request issued by client 202, it would typically have to be processed by a separate event services server before it could be executed by a separate application server. In embodiments described herein, however, a create job request issued by client 202 is directed to the combined server that is best suited to handle the message.

Referring to FIG. 2, when client 202 issues a message (e.g., a job request), the message is load balanced (1A) to one of the combined servers 220 or 240 and placed in a message queue 230 or 250, as described in conjunction with FIG. 1. The combined server to which the message is sent can locally create a job by converting the message into an execute task call (2A) and can notify client 202 (3A) that the message has been processed. The execute task call is then load balanced between available combined servers, such as combined servers 220 or 240, and a determination is made as to whether to execute the task locally or send it to another combined server (4A), as described in conjunction with FIG. 1. Once the task has been executed, the combined server can notify the server that originated the call that the created job has been completed.

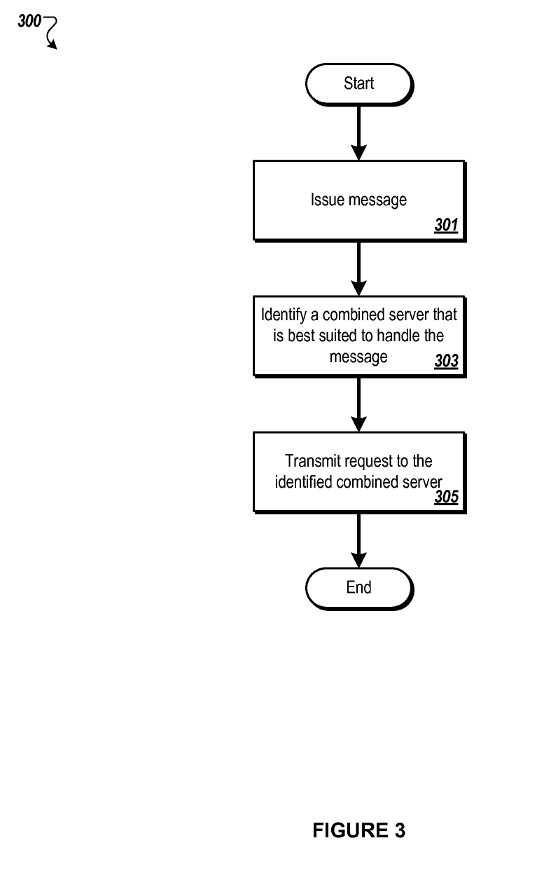

FIG. 3 illustrates one embodiment of a method 300 for load balancing a client message. Method 300 can be performed by processing logic that can comprise hardware (e.g., circuitry, dedicated logic, programmable logic, microcode, etc.), software (e.g., instructions run on a processing device), or a combination thereof. In one embodiment, method 300 is performed by a client such as client 102 or 112 of FIG. 1.

Referring to FIG. 3, at block 301, a message is issued for processing by a combined server. For example, the message may be issued by client 102 or 112, as described in conjunction with FIG. 1. At block 303, a combined server (e.g., combined server 120 or 140) is identified that is best suited to handle the message using load balancing, as described in conjunction with FIG. 1. At block 305, the message is transmitted to the identified combined server, where the message can be placed in a message queue (e.g., message queue 130 or 150). In some embodiments, the message may be transmitted via a communications network (e.g., network 162).

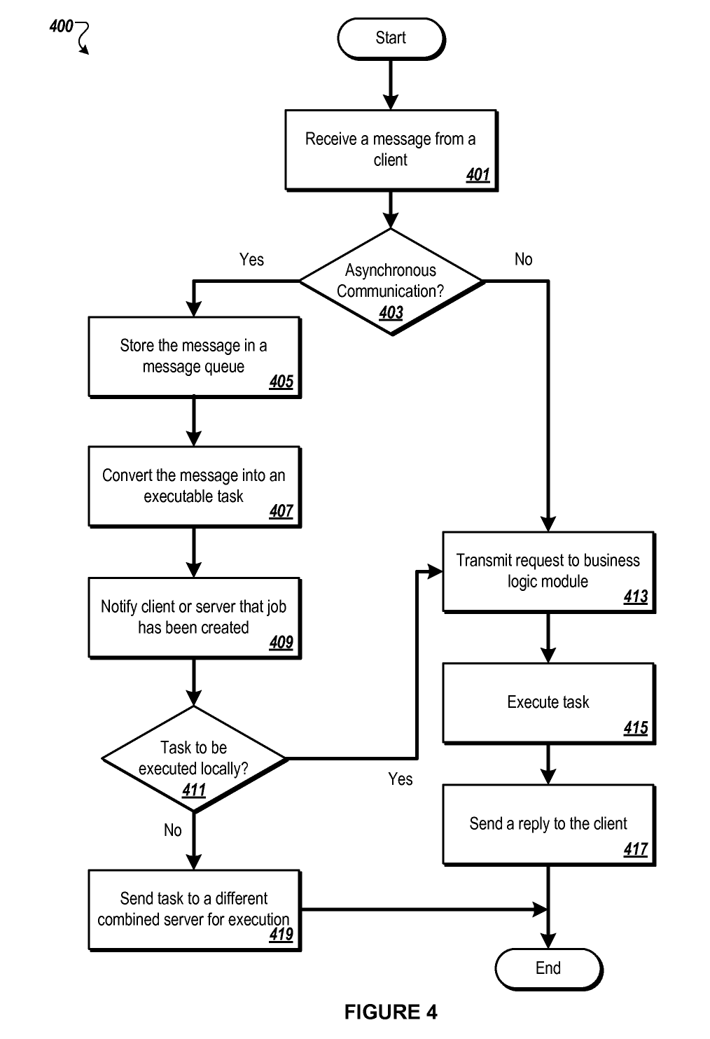

FIG. 4 illustrates one embodiment of a method 400 for processing a client message and executing a task by a combined server having event services (e.g., messaging services) and application server functionality.

Method 400 can be performed by processing logic that can comprise hardware (e.g., circuitry, dedicated logic, programmable logic, microcode, etc.), software (e.g., instructions run on a processing device), or a combination thereof. In one embodiment, method 400 is performed by a server such as a combined server 120 or 140 of FIG. 1.

Referring to FIG. 4, at block 401, a message is received from a client (e.g., client 102 or 112). The combined server can receive the message after being identified by a load balancer as better suited to handle the message than other combined servers. The combined server (e.g., combined server 120 or 140) may receive the message (e.g., a request to create an asynchronous job).

At block 403, a determination is made as to whether the received message is asynchronous. The combined server may determine (e.g., by a processing device) whether the received message is asynchronous by examining the message and comparing it to a list of known messages or message types or message subject. If, at block 403, it is determined that the message is asynchronous (e.g., a create job request), at block 405, the event services module (e.g., event services module 122 or 142) of the combined server stores the message in a message queue (e.g., message queue 130 or 150). When ready to handle the message, at block 407 the event services module (e.g., event services module 122 or 142) of the combined server converts the message into a task (e.g., an executable task). At block 409, the event services module notifies the client that the message was received and converted into a task (e.g., that the asynchronous job has been created). If at block 403, it is determined that the message is synchronous, at block 413, the message is transmitted directly to a business logic module (e.g., business logic module 124 or 144) for execution.

In one embodiment, an asynchronous message is converted into an executable task by the PDController service provided by the event services module. An executable the task is then created by the event services module of the combined server, and at block 411, a load balancing decision is made, deciding whether to execute the task locally by the business logic module of the local server or send it to another combined server for execution by the business logic module of the other server. In one embodiment, the load balancing decision is made by a load balancer (e.g., load balancer 126 or 146) by the combined server and is based, at least in part, on the number of calls currently executing on each server, as described in conjunction with FIG. 1. In one embodiment, the load balancing decision is made at least in part by a client (e.g., load balancer 106 or 116 of client 102 or 112, respectively), for example, based on a suggested load balancing policy provided to or specified by the client.

If at block 411, it is determined that the task should be executed locally (i.e., by the combined server on which the executable task was created at block 407), the executable task is transmitted to the business logic module at block 413, after which at block 415 the task is executed. The task may be executed by the business logic module on the local combined server. At block 417, a reply (or other message) is generated and sent informing the client or event services module that the task has been executed. If at block 411, it is determined that the task should be executed on another combined server, at block 419, the task is sent to the appropriate combined server. The other combined server may then execute the task without making another load balancing decision.

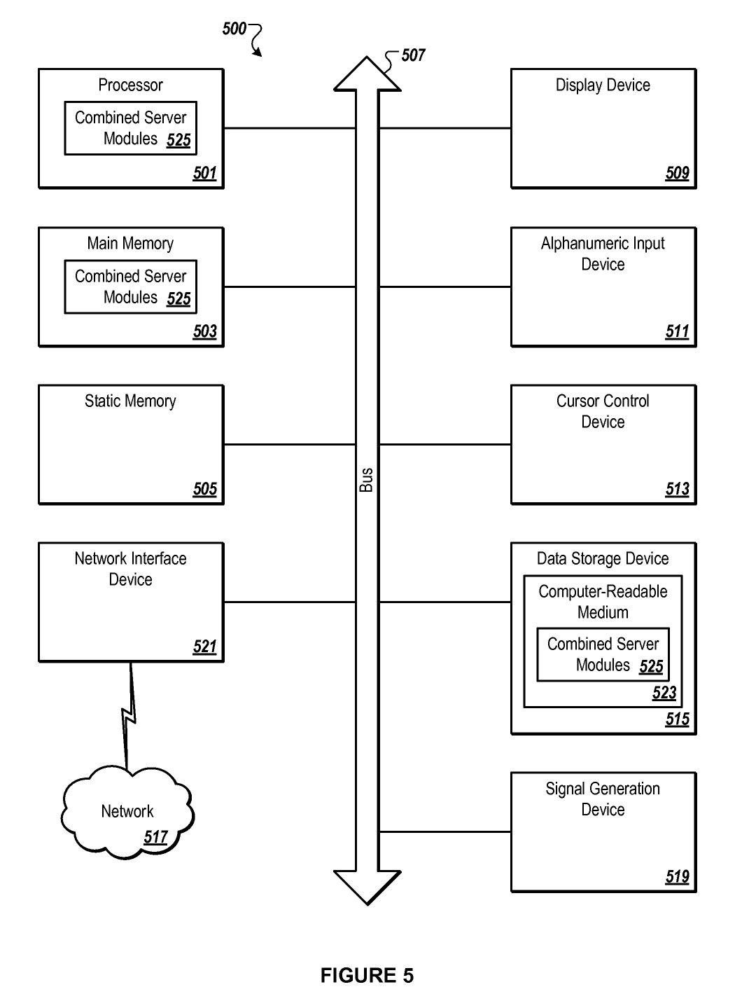

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 501, a main memory 503 (e.g., read-only memory (ROM), flash memory, dynamic random access memory (DRAM) such as synchronous DRAM (SDRAM), etc.), a static memory 505 (e.g., flash memory, static random access memory (SRAM), etc.), and a secondary memory 515 (e.g., a data storage device), which communicate with each other via a bus 507.

The processor 501 represents one or more general-purpose processing devices such as a microprocessor, central processing unit, or the like. More particularly, the processor 501 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 501 may also be one or more special-purpose processing devices such as an application specific integrated circuit (ASIC), a field programmable gate array (FPGA), a digital signal processor (DSP), network processor, or the like. The processor 501 is configured to execute processing logic of one or more combined server modules 525 (which may represent modules of combined servers 120 and 140) for performing the operations and steps discussed herein.

The computer system 500 may further include a network interface device 521. The computer system 500 also may include a display device 509 (e.g., a liquid crystal display (LCD) or a cathode ray tube (CRT)), an alphanumeric input device 511 (e.g., a keyboard), a cursor control device 513 (e.g., a mouse), and a signal generation device 519 (e.g., a speaker).

The secondary memory 515 may include a machine-readable storage medium (or more specifically a computer-readable storage medium) 523 on which is stored one or more sets of instructions (e.g., of combined server modules 525) embodying any one or more of the methodologies or functions described herein. The combined server modules 525 may also reside, completely or at least partially, within the main memory 503 and/or within the processor 501 during execution thereof by the computer system 500, the main memory 503 and the processor 501 also constituting machine-readable storage media. The combined server modules 525 may further be transmitted or received over a network 517 via the network interface device 521.

The machine-readable storage medium 523 may also be used to store the combined servers 120 and 140 of FIG. 1. While the machine-readable storage medium 523 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine that cause the machine to perform any one or more of the methodologies of the present invention. The term “machine-readable storage medium” shall accordingly be taken to include, but not be limited to, solid-state memories, and optical and magnetic media. The term “computer-readable storage medium” shall accordingly be taken to include, but not be limited to, transitory computer-readable storage media, including, but not limited to, propagating electrical or electromagnetic signals, and non-transitory computer-readable storage media including, but not limited to, volatile and non-volatile computer memory or storage devices such as a hard disk, solid-state memory, optical media, magnetic media, floppy disk, USB drive, DVD, CD, media cards, register memory, processor caches, random access memory (RAM), etc.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “storing”, “associating”, “facilitating”, “assigning”, “receiving”, “creating”, “determining”, “executing”, “transmitting”, “storing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. For example, techniques described herein can be implemented for web services. When a client makes a web services call, it can use a load balancer to identify the best suitable combined server to handle the call. The combined server receives the call and can process it into a task. Using a load balancer, the task can then be directed to the best suitable combined server to handle the task. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method comprising:
receiving, by a combined server, a message from a client, the combined server comprising a message queue, and the combined server providing event services and application server functionality;
storing the message in the message queue;
creating a task corresponding to the message;
determining, by the combined server, whether to execute the task locally by the combined server or on a remote combined server; and
in response to the combined server determining that the task is to be executed locally, executing the task by the combined server; and
in response to the combined server determining that the task is to be executed remotely, transmitting the task to the remote combined server.

2. The method of claim 1, wherein the message is stored in the message queue in response to determining that the message is an asynchronous message.

3. The method of claim 1, further comprising:
transmitting a notification to the client that the task corresponding to the message was created.

4. The method of claim 1, wherein the combined server is selected to receive the message based on a client-side load balancer.

5. The method of claim 4, wherein the combined server is selected to receive the message further based on a load balancing policy of the client-side load balancer, the load balancing policy being specified by the client.

6. The method of claim 4, wherein determining whether to execute the task locally by the combined server or by the remote combined server comprises determining based on a server-side load balancer.

7. The method of claim 1, wherein the message is at least one of an automated request generated by a manufacturing tool, a maintenance request, a request for creation of a lot for processing, or a request to track the processing of the lot.

8. A system comprising:
a memory for storing a message queue; and
a processing device, coupled to the memory, for providing event services and application server functionality, wherein the processing device is to:
receive a message from a client;
store the message in the message queue;
create a task corresponding to the message;
determine whether to execute the task locally or on a remote combined server; and
execute the task in response to determining that the task is to be executed locally; and
transmit the task to the remote combined server in response to determining that the task is to be executed remotely.

9. The system of claim 8, wherein the message is stored in the message queue in response to determining that the message is an asynchronous message.

10. The system of claim 8, wherein the processing device is further to:
transmit a notification to the client that the task corresponding to the message was created.

11. The system of claim 8, wherein the processing device is selected to receive the message based on a client-side load balancer.

12. The system of claim 11, wherein the processing device is selected to receive the message further based on a load balancing policy of the client-side load balancer, the load balancing policy being specified by the client.

13. The system of claim 11, wherein determining whether to execute the task locally or by the remote combined server comprises determining based on a server-side load balancer.

14. The system of claim 8, wherein the message is at least one of an automated request generated by a manufacturing tool, a maintenance request, a request for creation of a lot for processing, or a request to track the processing of the lot.

15. A non-transitory computer-readable storage medium storing instructions which, when executed by a combined server, cause the combined server to perform operations comprising:
receiving, by the combined server, a message from a client, the combined server comprising a message queue, and the combined server providing event services and application server functionality;
storing the message in the message queue;
creating a task corresponding to the message;
determining, by the combined server, whether to execute the task locally by the combined server or on a remote combined server; and
in response to the combined server determining that the task is to be executed locally, executing the task by the combined server; and
in response to the combined server determining that the task is to be executed remotely, transmitting the task to the remote combined server.

16. The non-transitory computer-readable storage medium of claim 15, wherein the message is stored in the message queue in response to determining that the message is an asynchronous message.

17. The non-transitory computer-readable storage medium of claim 15, wherein the operations further comprise:
transmitting a notification to the client that the task corresponding to the message was created.

18. The non-transitory computer-readable storage medium of claim 15, wherein the combined server is selected to receive the message based on a client-side load balancer.

19. The non-transitory computer-readable storage medium of claim 18, wherein the combined server is selected to receive the message further based on a load balancing policy of the client-side load balancer, the load balancing policy being specified by the client.

20. The non-transitory computer-readable storage medium of claim 18, wherein determining whether to execute the task locally by the combined server or by the remote combined server comprises determining based on a server-side load balancer.
